(19) United States
(12) Patent Application Publication
(10) Pub. No.: US 2007/0163566 A1
(43) Pub. Date: Jul. 19, 2007

(54) Adjustable handle for a concrete saw

(76) Inventors: Adam Johnson, Olathe, KS (US); Michael Kingsley, Wellsville, KS (US); John Gibel, St. Joseph, MO (US)

Correspondence Address: HENRICKS SLAVIN AND HOLMES LLP;SUITE 200, 840 APOLLO STREET, EL SEGUNDO, CA, 90245, US

(21) Appl. No.: 11/332,499

(22) Filed: Jan. 14, 2006

(51) Int. Cl. B28D 1/04

(52) U.S. Cl. 125/13.01

(57) ABSTRACT

A movable saw has a handle that is movable sideways relative to the saw. The handle may also be movable so as to change its vertical position.

### BACKGROUND

1. Field

This relates to movable machinery controlled by an operator, including concrete saws, portable motor-driven machining and finishing equipment, and the like.

2. Related Art

Movable machines are often manually guided by operators, for example using handles mounted on the machine. Walk-behind concrete saws are an example of movable machines where the operator manually guides the saw to cut along the desired line or other path. Other equipment can also be used as examples, but concrete saws will be used as examples herein. A schematic of an example concrete saw is shown in FIG. 13 at 30, and includes a handle assembly 31 at a back portion of the saw 30 and mounted to or supported by a suitable frame or other structure represented by the block 32. In this example, the handle assembly 31 includes a left handle 33 and a right handle 34 mounted to or supported by a handle cross bar 35, which in turn is mounted to the frame 32 through a central mounting post 36. In the example of a walk behind saw, the operator grasps one or both of the handles 33 and 34 to guide the saw so the saw blade 37 follows the desired cutting path.

As the saw is to move forward, the saw blade 37 hits concrete (or another work piece in the example of other movable equipment). The concrete tends to slow down the saw through what is in effect a counter force designated Fb against the forward motion of the saw blade 37. To keep the saw moving forward, the operator pushes the saw forward by the handles 33 and 34. In some saws, the saw moves forward when the operator pushes the saw, and in other saws powered drive wheels under the saw (not shown) push the saw forward, with or without the help of the operator. To ultimately achieve forward progress in the cutting, the operator and/or any drive wheels must overcome the drag force of the saw blade Fb with a greater opposite force, designated in this example as Fh. It will be assumed for the present example that the drive force Fh is derived exclusively from the operator pushing on the handles 33 and 34, with an equal amount of force applied to each of the handles. Therefore, the sum of the forces applied to each of the handles will be Fh. The drive force Fh effectively occurs at the center of the saw through the central mounting post 36, and the operator pushes the saw to move it forward and continue cutting. Generally, the operator will push the saw forward in the desired direction of the cut until the cut is complete.

As noted in FIG. 13, the saw blade 37 is mounted to the right side of the saw, while it is understood that the saw blade can also be mounted on the left side of the saw, on the blade drive shaft 38. In actual practice, the forward motion of the saw in the direction of the drive force Fh is impeded by the saw blade drag force Fb applied at the right side of the saw. Additionally, because the drive force Fh is not aligned with the saw blade drag force Fb, the drag force Fb tends to pull the saw to the right, in a manner similar to a flat tire on the right front of a car. Therefore, through experience, the operator pushes the saw in a direction (slightly toward the left) so the net effect is to overcome the off-center drag force of the saw blade Fb and move along the line of cut.

To insure properly aligned travel, the operator typically must pay close attention to the cutting while at the same time pushing the saw forward and to the left to effectively counter the drag force Fb of the saw blade. However, it is difficult for the operator to see conveniently the saw blade and to watch the cutting progress when standing behind the saw and pushing at the handles. Likewise, with the example of a saw having drive wheels, it is difficult for the operator to see conveniently the saw blade for cutting while guiding the saw using the handles at the rear of the saw. Similar comments apply to a saw with the saw blade mounted to the left side of the blade drive shaft 38. The operator pushes the saw forward and slightly to the right to compensate for the drag force Fb of the saw blade on the left side of the saw.

### SUMMARY

Movable machinery is described, for example a movable concrete saw, having a movable structure to be used by the operator to more easily guide the machine. In one example, an adjustable handle allows an operator to selectively position the handle relative to the rest of the saw. In another example, a movable handle allows an operator to more easily view the cutting progress. In a further example, one or more structures are movable to allow the operator to more easily complete the operation.

In one example of a movable machine, a concrete saw has a blade off center relative to the saw. A structure that can be used by an operator to guide the saw is movable at least laterally relative to the blade. In one example, the structure is a handle having a handle surface sufficiently large to allow an operator to grasp the surface. At least part of the structure can be a movable element, a bar, a tube, a telescoping tube, or the like. In one example where the saw blade is positioned at a side of the saw, the handle may have a handle portion that can be positioned in a plane containing the blade, for example at a point behind the blade. In another example, the structure is a handle having a width approximately equal to the width of the saw, and a portion of the handle is movable to a point behind the blade. For example, the handle may be at least 90 percent of the width of the saw.

In another example of a movable machine, a concrete saw includes a handle and a handle support for the handle wherein the handle support is configured to allow the handle to move sideways relative to the rest of the saw. For example, the handle support can be movable sideways and in another example, the handle can be movable sideways relative to the handle support. In a further example, both the handle support and handle can be movable sideways. Another example has the handle support movable other than sideways, and an additional example has the handle support movable in at least two directions, such as sideways and pivotally. The handle support can be movable to a position other than the center of the saw. In a further configuration of a handle and handle support, a clamp can be used for releasably fixing the handle support relative to the saw. In these examples, one configuration of the sideways movement has the handle moving linearly.

In an additional example of a concrete saw, a handle on the saw may be laterally movable relative to the frame. The handle may be a straight handle, a curved handle, a handle whose length is changeable, a handle with a telescoping portion, a sliding portion, or other moving portions. The handle, or portions thereof, can also move in other directions than laterally.

In another example of a movable machine, a concrete saw having an off-center blade has a frame structure supporting a handle support wherein the handle support is movable on the frame structure sideways, in one example linearly. The frame structure supporting the handle support may be movable relative to the frame, and it may pivot relative to the frame. The frame structure supporting the handle may also be fixed relative to the rest of the saw. The frame structure supporting the handle support may have an outer polygon configuration, such as a hexagon or other uniform shape. The handle support may then pivot about the frame structure, for example to adjust the height of the handle. Where the outer configuration is a polygon, the handle support may be moved to discrete positions for changing the height of the handle.

In a further example of a movable machine, a handle for the machine is supported by a handle support in the form of a yoke movable relative to the rest of the saw. In one example, the yoke includes two pieces separable or movable from each other. In another example, a first portion of the yoke is movably supported relative to the frame. Alternatively, or in addition, a second portion of the yoke and the handle are movable relative to each other. The first portion may be movable laterally and in a vertical direction, for example by pivoting. The first portion may include a non-circular surface to help in securing an angular position of the yoke. In a further example, a releasable element may be used for releasably locking the yoke relative to the rest of the saw.

An additional example of a movable machine includes a concrete saw having a handle and a handle support wherein the handle support may be movable laterally and in a vertical direction, such as to allow the operator to position the handle at a comfortable height, for example waist height. The saw may also include a releasable securing device for securing the handle support relative to the rest of the saw. The handle is also preferably movable laterally, and the handle may include handle grips sufficiently short to allow the handle to move laterally so as to have a portion of the handle behind the blade.

These and other examples are set forth more fully below in conjunction with drawings, a brief description of which follows.

### BRIEF DESCRIPTION OF THE DRAWINGS

FIG. 1 is an upper right rear isometric view of a movable apparatus in the form of a portable concrete saw having an adjustable handle.

FIG. 2 is a rear elevation view of the concrete saw of FIG. 1.

FIG. 3 is a left side elevation view of the concrete saw of FIG. 1.

FIG. 4 is a top plan view of the saw of FIG. 1.

FIG. 5 is a top plan view of a handle assembly shown with a frame portion for use with the saw of FIG. 1.

FIG. 6 is a side elevation view of the handle assembly of FIG. 5.

FIG. 7 is an exploded view of the handle assembly of FIG. 5.

FIG. 8 is a top plan view of another handle for use with the saw of FIG. 1.

FIG. 9 is an isometric view of another handle for use with the saw of FIG. 1.

FIG. 10 is an isometric view of another handle for use with a saw of FIG. 1.

FIG. 11 is an isometric view of a portion of a saw showing an alternative handle arrangement.

FIG. 12 is a side elevation view similar to that of FIG. 6 of a handle assembly for use with the saw of FIG. 1.

FIG. 13 is a top plan view and schematic of an example of a saw.

### DETAILED DESCRIPTION

This specification taken in conjunction with the drawings sets forth examples of apparatus and methods incorporating one or more aspects of the present inventions in such a manner that any person skilled in the art can make and use the inventions. The examples provide the best modes contemplated for carrying out the inventions, although it should be understood that various modifications can be accomplished within the parameters of the present inventions.

Examples of movable machinery, for example machines for cutting concrete, are described. Depending on what feature or features are incorporated in a given structure or a given method of use, benefits can be achieved in the structure or the method. For example, machines having movable handles may make easier more accurate concrete cutting. They may also allow better visibility of the cutting process, and they may include handles that experience a lower vibration than handles in other configurations.

These and other benefits will become more apparent with consideration of the description of the examples herein. However, it should be understood that not all of the benefits or features discussed with respect to a particular example must be incorporated into a machine, tool, component or method in order to achieve one or more benefits contemplated by these examples. Additionally, it should be understood that features of the examples can be incorporated into a machine, tool, component or method to achieve some measure of a given benefit even though the benefit may not be optimal compared to other possible configurations. For example, one or more benefits may not be optimized for a given configuration in order to achieve cost reductions, efficiencies or for other reasons known to the person settling on a particular product configuration or method.

Examples of a number of machine configurations and of methods of using the tools are described herein, and some have particular benefits in being used together. However, even though these apparatus and methods are considered together at this point, there is no requirement that all of them be combined, used together, or that one component or method be used with any other component or method, or combination. Additionally, it will be understood that a given component or method could be combined with other structures or methods not expressly discussed herein while still achieving desirable results.

Concrete saws are used as examples of movable machines that can incorporate one or more of the features and derive some of the benefits described herein. Concrete saws often have handles at the back of the saw allowing an operator to guide or position the saw as desired. However, machines other than concrete saws can benefit from one or more of the present inventions.

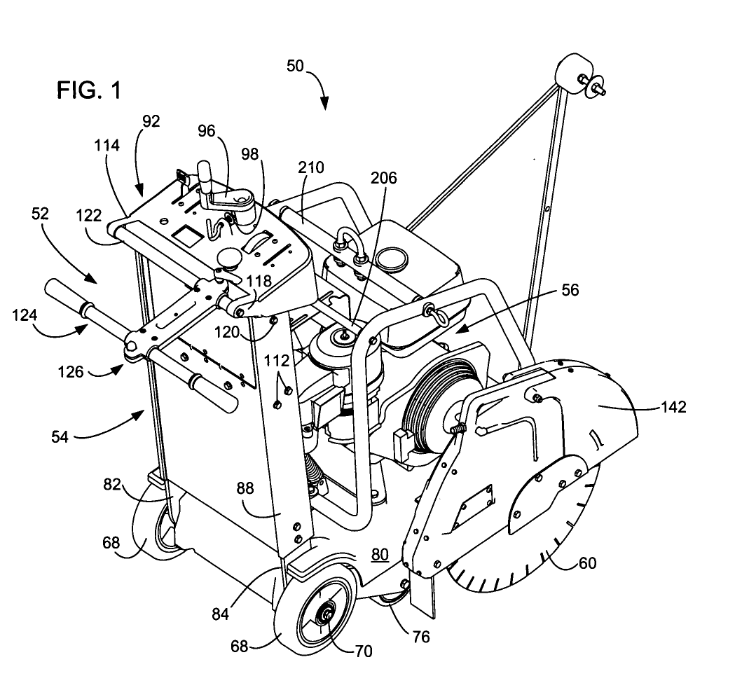

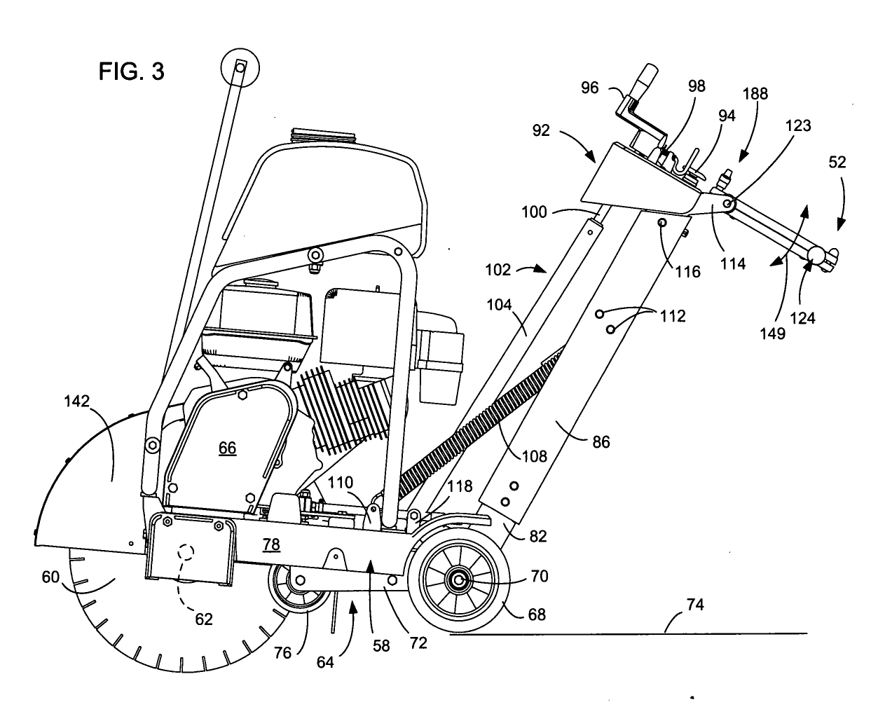

In one example of a movable machine (FIGS. 1-4), a portable saw 50 includes a handle assembly 52 supported on an upper portion 54 of a frame assembly, described more fully below. An engine 56 is supported on an engine platform 58 for driving a saw blade 60, in the present examples mounted on and supported by a drive shaft 62 (FIG. 3) so that the blade is at a right front portion of the saw. As discussed more fully below, the handle assembly in the example shown in FIGS. 1-4 is configured to allow a portion of the handle assembly to be moved laterally, and in one example, to allow a portion of the handle to be positioned behind the blade.

Considering the saw structure in more detail, the frame assembly can take a number of configurations, and those skilled in the art will appreciate that movable machines with which various parts of the present examples can be used are also numerous. In the example shown in FIGS. 1-4, the frame assembly 64 includes a first frame element in the form of the engine platform 58. The engine platform 58 in the present examples supports the motor 56, a drive assembly 66 and the blade 60. The engine platform 58 can have a number of shapes and sizes, and the configuration of the engine platform is preferably such as to reliably support the motor 56, the drive assembly 64 and the blade 60 during normal operation over the lifetime of the saw. The engine platform shown in FIGS. 1-4 is a cast part, and includes structures for strength, mounting structures for various components, some of which are described herein, as well as structures for receiving an axle assembly for the rear wheels 68 of the saw. In the present example, the engine platform 58 pivots around the rear wheel axle, represented by the bolts 70, allowing the blade 60 to be raised and lowered.

The frame assembly 64 also includes a second frame element, including in the present example a chassis or carriage assembly 72. The carriage assembly 72 is supported on a concrete surface 74 by the rear wheels 68, on the left and right side of the carriage assembly 72, and by left and right front wheels 76, each of the front wheels being mounted on the inside surfaces of respective side walls of the carriage assembly 72. The front wheels and the respective side walls of the carriage assembly 72 are dimensioned so as to fit between corresponding left and right side walls 78 and 80 (FIGS. 1 and 3), respectively, of the engine platform 58. The terms “left” and “right” as well as “front” and “back” when used in the context of this saw example are used from the point view of an operator standing behind the saw, where the blade is at the front of the saw.

The carriage assembly 72 includes left and right posts 82 and 84, respectively, extending upwardly and rearwardly from the carriage assembly (FIGS. 1-3). The posts 82 and 84 are fixed relative to, and may be integral with, the carriage assembly 72. The posts 82 and 84 receive and support the handle assembly 52 extending rearwardly and/or upwardly from the carriage assembly. In the present example, a left beam 86 and a right beam 88 are fastened to and supported by respective ones of the left and right posts 82 and 84, so that the posts are preferably fixed relative to the carriage assembly. As the posts are moved, such as through the handle assembly 52, the carriage assembly is also moved. Additionally, with the engine platform 58 pivotally mounted about the rear wheel axle, the engine platform 58 and the parts supported by it can be moved through movement of the handle assembly relative to the ground 74.

The posts and the carriage assembly are relatively rigid structures with respect to each other so that the carriage assembly can reliably support the engine platform and any motor, drive and blade combination, and so that the handle assembly can be used conveniently to move the saw during use, for storage or for transporting to or from a job site. While the frame assembly 64 can take a number of configurations, the present examples have the engine platform 58 pivoting around an axis coaxial with the axle for the rear wheels 68 relative to the carriage assembly 72 and the posts 82 and 84. The carriage assembly and the portion of the frame supporting the handle assembly are preferably fixed relative to each other so that raising and lowering the saw blade by raising and lowering the engine platform keeps the handle assembly at a relatively constant position for the operator. Other configurations can have the frame portion supporting the handle assembly mounted to the engine platform instead of the carriage assembly, or one or more of the wheels supported independently on the engine platform, thereby changing the configuration for or eliminating the carriage assembly, as well as other configurations. Other configurations may use skids instead of wheels to support a saw on the concrete, and other configurations of a saw can use other mechanisms to raise and lower the blade for cutting. Additionally, that portion 54 of the frame supporting the handle assembly 52 can be formed from a single post or from more than two posts. A single post configuration is shown in U.S. Pat. No. 5,381,780, incorporated herein by reference, in which a handle assembly is generally indicated by reference 56. However, for purposes of the present description, the handle support 58 and handle extension 60 in that patent will be considered part of the frame structure supporting the cross bar 62 of the handle.

In the present example, the left and right beams 86 and 88 support a control console 92 accessible to an operator for controlling various functions of the saw. The console may include an engine control 94, for example for turning off the engine, and a blade height control handle 96. The blade height control handle 96 can be locked in position using a biased handle locking pin 98 (FIGS. 1-4). The control console or other locations around the posts can also include other components such as a water supply valve, and other elements useful for operating the saw.

The blade height control handle 96 is fixed to an upper rotating portion 100 of a screw adjustment assembly 102 centered width-wise of the saw. The screw adjustment assembly 102 adjusts the height of the blade through rotating of the blade height adjustment handle 96 about a predominantly vertical axis, parallel to the upper rotating portion 100 of the screw adjustment assembly. The upper rotating portion 100 includes a threaded portion engaging a complementary threaded portion on the inside of the stationary tube 104, so that threading the upper rotating portion 100 into or out of the stationary portion 104 changes the length of the screw adjustment assembly. The end of the stationary tube 104 opposite the upper rotating portion 100 is fixed to and supported by a mounting bracket 106, which in turn is mounted to and supported by the engine platform 58. Changing the length of the screw adjustment assembly raises or lowers the saw blade relative to the ground 74 by pivoting engine platform 58 about the rear wheel axle relative to the carriage 72.

The frame assembly 64 also includes a bias assembly in the form of one or more springs 108 for biasing the engine platform 58 upward toward the left and right beams 86 and 88. The springs 108 are mounted to respective brackets 110 fixed to and supported by the engine platform 58. The opposite ends of the springs 108 are mounted to an adjustable cross bracket extending between the left and right beams 86 and 88 through fasteners 112. The lengths of the springs can be adjusted at the cross brackets so as to change the biasing force exerted on the engine platform 58. The springs make easier the raising and lowering of the saw blade through turning of the blade height adjustment handle 96.

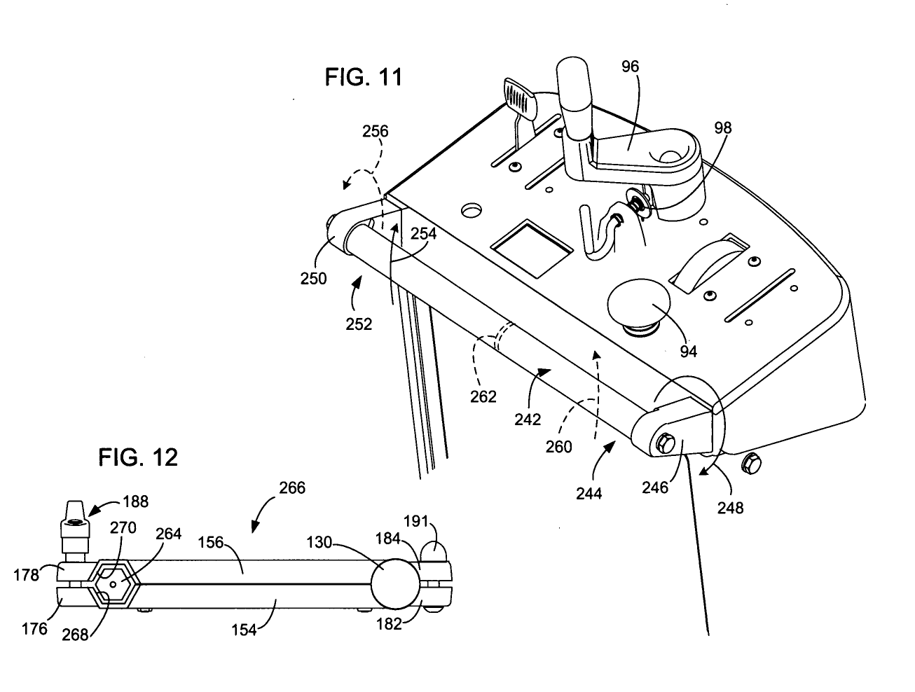

The saw in the example of FIGS. 1-4 includes a support structure for supporting the handle assembly 52. In this example, the handle support structure includes a left side bracket 114 mounted and fixed to the left side beam through a fastener 116. The handle support also includes a right side bracket 118 mounted and fixed to the right side beam through a fastener 120. The left and right side brackets extend rearwardly from the console 92 and the side beams 86 and 88 a sufficient distance to allow the handle assembly 52 to move, in the manner described herein. The side brackets can take a number of configurations, one of which is shown in FIGS. 1-4, and another of which is shown in FIG. 11. In the example shown in FIG. 1-4, the side brackets are fixed relative to the supporting frame. A relatively rigid handle support bar 122 is fixed to and supported by the side brackets through respective fasteners 123, which may take the form of bolts or other means for securing the handle support bar in place. In the example of the handle support bar 122 shown in FIGS. 1-4, the bar is fixed laterally and otherwise so that the bar does not move relative to the brackets and relative to substantially the rest of the saw frame structure. In other examples, the bar may be releasably pivotal relative to the brackets to allow the handle bar assembly 52 to pivot about an axis, such as an axis defined by the bar 122. In the example shown in FIGS. 1-4, the handle support bar 122 has a substantially circular outer profile with a smooth surface. In other configurations, the handle support bar can have a non-circular outer profile and/or the surface may have discontinuities around its periphery for supporting the handle assembly 52. Discontinuities may include knurling, grooves or ridge or rough surface textures. The stationary bar 122 can also be configured so that an operator can easily grasp the bar, thereby allowing the bar to be used as a handle.

A movable handle can also take a number of configurations. In the example of the handle assembly shown in FIGS. 1-6, the handle assembly 52 includes a handle 124. The handle is supported by the frame through the bar 122 and through a handle support 126. The handle support 126 is a link between the bar 122 and the handle so that the handle can be supported by the frame. The handle support 126 includes a frame end portion 128 for mounting the handle support to the frame through the bar 122, and also includes a handle-end portion 130 for engaging and supporting the handle 124. In the example shown in FIGS. 1-6, the handle 124 is movable sideways or laterally relative to the saw. The movement of the handle in FIGS. 1-6 is linear. The handle 124 is movable either by moving the handle relative to the handle support 126, or, where the handle support 126 is movable relative to the bar 122 as in the present example, the handle 124 is also movable by moving the handle support 126 relative to the bar 122. The handle can also be movable by a combination of movement of the handle relative to the handle support and movement of the handle support relative to the bar 122. Other configurations for allowing the handle to move can be used, some of which are discussed with respect to the Figures.

As used herein, the word “handle” will be defined in a generic sense as any device or implement that an operator can use to guide and/or move the saw through the operator's energy, for example by pushing and/or pulling. Typically the handle will be used with the hand, but the handle can be used to guide and/or move the saw without the operator using the hands, for example by pushing the operator's thigh or hip against the handle to move or guide the saw. The handle need not have a handle grip, or a surface configuration suitable only for use with a hand, such as finger grooves or the like, but can be any structure suitable for use by the operator to move and/or guide the saw through the operator's energy such as by pushing and/or pulling. Remote controls held in the hand for guiding and/or moving the saw using motors or other independent energy means such as radio controls would not be included in the term handle. Therefore, the term “handle” as used herein will be a structure that can be used by an operator to guide and/or move the saw through the operator's energy, for example by pushing and/or pulling.

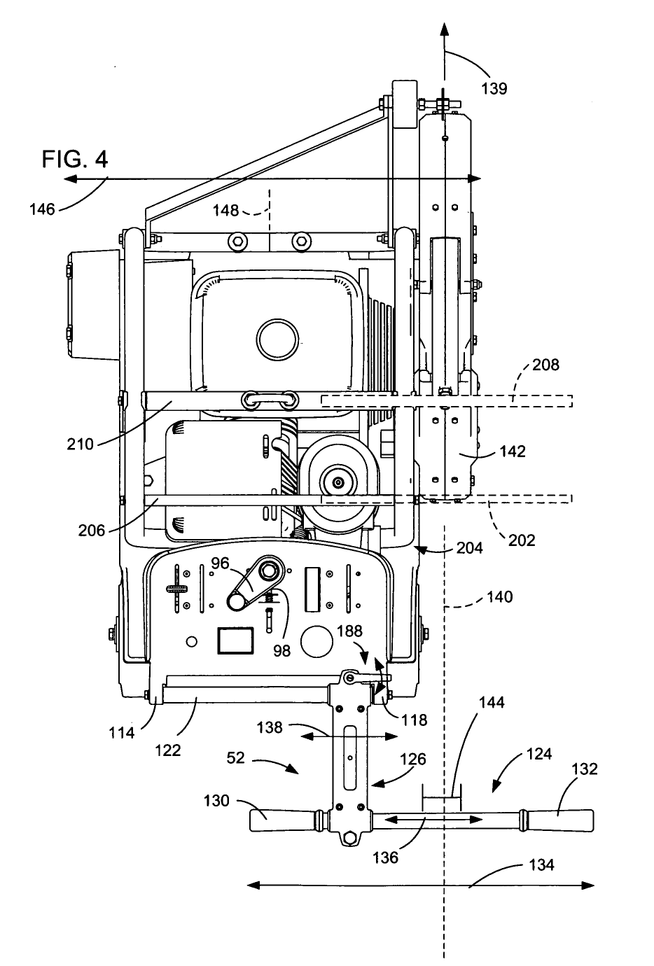

In several of the present examples, a structure, for example a handle, that can be used by an operator to guide and/or move the saw is movable from a first position to a second position, each of which positions can be used to guide and/or move the saw. For example, the structure can be located at a first position at which the structure can be used to guide and/or move the saw, and the structure can be located at a second position at which the structure also can be used to guide and/or move the saw. In several examples where the structure is movable, the structure can be used as a handle at the first position where the area of saw operation might be restricted, such as next to a wall, and the same handle at a second position can be used where operation is less restricted, such as in the middle of a room or on open pavement. The ability to move the handle to several positions makes the use of the saw more flexible. Additionally, movability of the structure laterally or sideways relative to the rest of the saw may be helpful to more predictably guide or move the saw, for example where part of the movable structure can be positioned at or near a point behind the saw blade, thereby reducing the tendency to move the saw sideways when pushing on the handle. Lateral and sideways movement of the structure, for example a handle, is movement of a point on the structure (for example an end of the handle) closer to or farther from a plane containing a center plane of the saw. A center plane of the saw may be centered between a given pair of wheels, or between side edges of the engine platform, between ends of a saw blade drive shaft, or between other points on the saw. Lateral or sideways movement of the structure, for example a handle, positions the structure so that in at least one position, the structure is not substantially centered width-wise of the saw. For example, as shown in FIG. 4, both the handle support 126 and the handle 124 are not substantially centered. The structure can also move vertically, or pivotally, as represented in FIG. 3.

In the examples of the saw shown in FIGS. 1-4, the handle 124 is part of the handle assembly 52. The handle includes a handle surface sufficiently large to allow handling by an operator. In the example shown in FIG. 1-4, the handle surface includes left and right grips 130 and 132, respectively, positioned at the corresponding ends of the handle 124. The grips can be integrally formed on the handle, or the grips can be placed on the handle separately. As noted earlier, the handle surface need not be a specially formed surface. For example, in the handle 124 the surfaces of the handle between the grips 130 and 132 can also serve as handle surfaces. Similar comments apply with respect to the other examples of handles discussed herein.

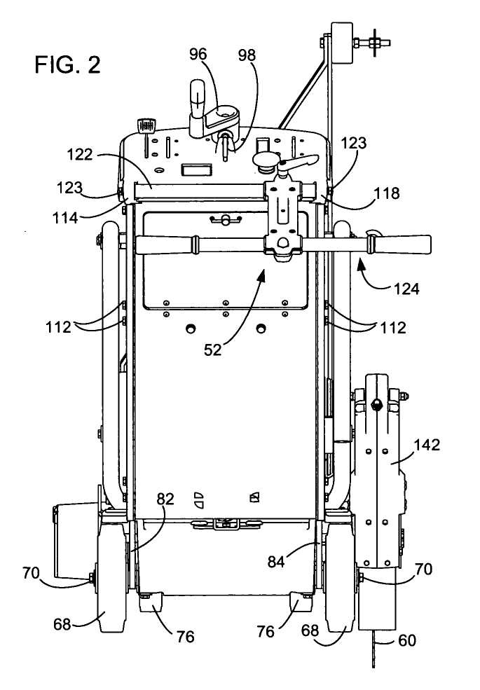

As evident from the scale of the drawings, for example FIGS. 2 and 4, the handle 124 has a length 134 that is approximately the same as the overall width of the saw. In saws similar to those described, a handle having a length comparable to the width of the saw will have multiple places where an operator can grasp the handle. Therefore, the operator can hold the handle not only at the grips 130 and 132 but also at portions of the handle between the grips.

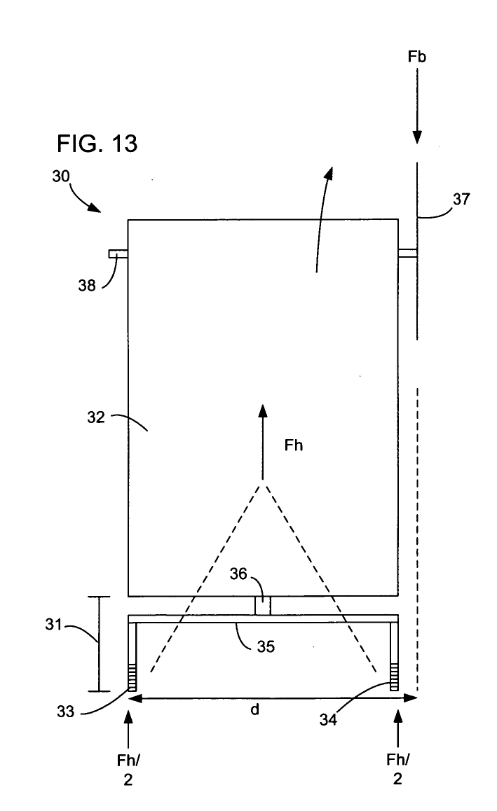

As shown for example in FIG. 4, the handle is movable sideways relative to the saw, as represented by the arrow 136. The sideways movement 136 can occur either by moving the handle 124 relative to the handle support 126, by moving the handle support 126 relative to the handle support bar 122, or both. Sideways movement of the handle support 126 is represented by the arrow 138. In one example, as shown in FIG. 4, the right portion of the handle is movable into a plane 140 that includes the saw blade within the blade guard 142. In the position shown in FIG. 4, the right side of the handle is moved into and beyond the plane 140. Additionally, the position of the handle shown in FIG. 4 has an approximate middle portion 144 of the handle directly behind the blade. An ideal hypothetical example having the exact middle portion of the handle intersecting the plane of the blade and an operator applying equal forces to identical points on each of the left and right grips 130 and 132 would produce a force equal and opposite to the blade drag force Fb represented in FIG. 13. As a result, the operator would be pushing the saw along a straight cutline 139 against the drag force of the blade. Little if any adjustment is applied in order to keep the cutting along a straight line. In other examples where the plane 140 of the blade does not precisely bisect the handle 124, or where the operator does not apply equal forces to the left and right handle grips, the operator may make adjustments while pushing the saw forward to keep the saw on a straight line. The operator may also make adjustments to account for possible drag created by the wheels on the pavement or other forces tending to take the saw off a straight line.

The handle 124 is preferably movable to a number of positions relative to the plane 140 of the saw blade. In one example, the position of the handle 124 can be described as a function of how close an end of the handle approaches the plane of the saw blade. Specifically, how close an end of the handle 124 gets to the plane 140 of the saw blade can be described as a function of the overall width of the saw. The overall width of the saw in the example of the saw shown in FIGS. 1-4 is represented by the arrow 146 measured or taken when the handle 124 is centered relative to a center line 148 of the saw. The overall width is taken to be between the left most portion of the saw and the right most portion of the saw. In the example shown in FIG. 4, the handle 124 is movable sideways so that the right side of the handle approaches and goes beyond the plane 140 of the saw blade. This can occur with the handle assembly shown in FIGS. 1-4 where the handle 124 has a length that is approximately the same as the overall width 146 of the saw, or at least about 75-100 percent of the overall width of the saw. However, there may be situations where the handle 124 does not move sideways enough to go through the plane 140 of the saw blade. Nonetheless, if the right side of the handle gets close enough to the plane 140 of the saw blade, benefits of having the handle movable sideways can still be obtained, for example to make it easier for the operator to control the movement of the saw. In one example, the right side of the handle approaches the plane 140 of the saw blade to within a separation distance that is less than or equal to about 10 percent of the overall width 146 of the saw. Improved handling can be achieved when the separation distance is less than 10 percent, but improvements are still possible when the separation distance is greater than 10 percent.

Guiding the saw can be made easier when the end of the handle goes beyond the plane 140 of the saw blade. For example, when the plane of the saw blade bisects the middle portion 144 of the handle (FIG. 4), guiding of the saw using the handle 124 is made easier. While exactly bisecting the handle 124 with the plane 140 of the saw blade is desirable, having the plane 140 of the saw blade pass through the middle portion 144 of the handle is also desirable. The width of the middle portion 144 that the plane 140 passes through may range between five and 10 percent of the overall width of the saw, and may even be between 20 and 25 percent to achieve easier handling. However, whenever the handle crosses the plane of the blade, some measure of easier handling is obtained, and it also allows the operator to move to a position relative to the saw where it is easier to see the blade or the cutting operation. Additionally, any significant re-positioning of the handle toward the plane of the blade may improve the operator's ability to watch the cutting operation.

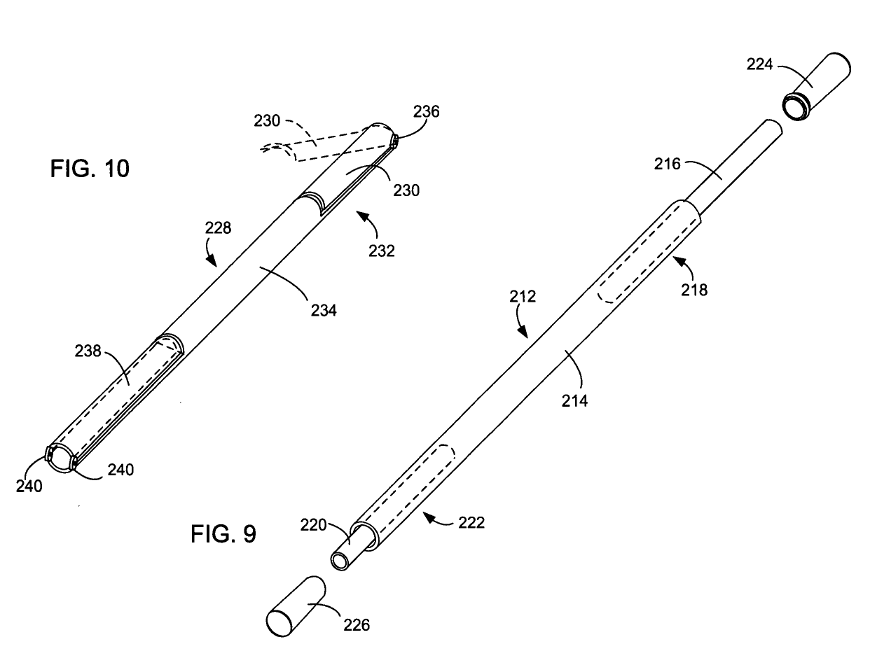

In the example of the handle shown in FIGS. 1-6, the handle 124 is formed from a hollow round and straight tube with round grips placed on the ends of the tube. The left end of the handle extends toward or beyond the left side of the saw frame and the right end of the handle extends toward or beyond the right side of the saw frame. The tube can be formed from metal, plastic or other reliable material suitable for the application. The handle can also be solid or formed in configurations other than a tube. In the example where the saw is about 22 to 24 inches wide (width 146 in FIG. 4), the handle is preferably between about 15 to 20 or 21 inches long. As a percentage of the saw width, the handle length from tip to tip (when collapsed or positioned to the shortest length—compare FIGS. 9 and 11) is in the present example about 60% and preferably between 80% and 85%. The grips can be rubber, Neoprene, plastic or other material suitable for grasping by an operator or otherwise used for guiding or moving the saw.

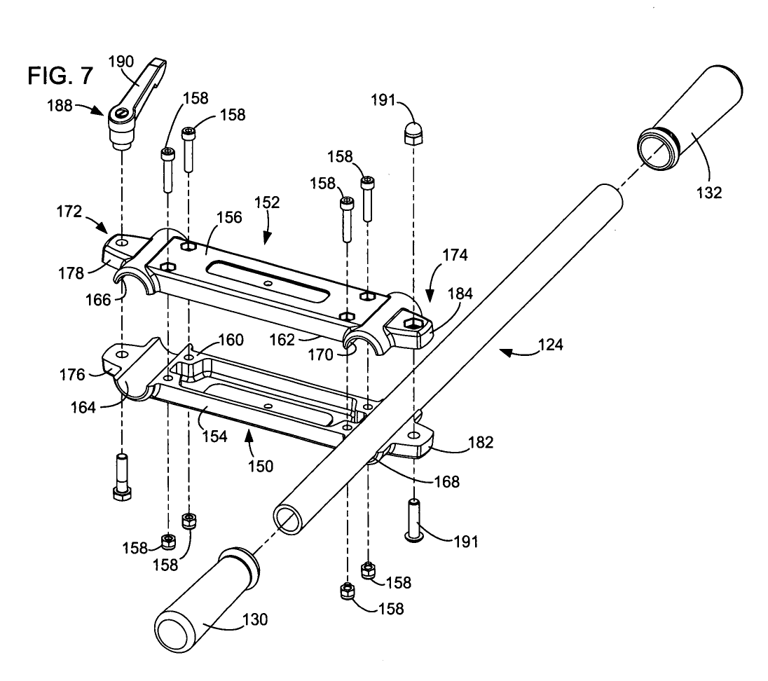

The handle support 126 is movable sideways relative to the frame on the stationary bar 122, and also other than sideways, such as pivotally about the stationary bar as represented by the arrow 149 (FIG. 3). In the example shown in FIGS. 1-6, the handle support may be a split bar that can be releasably locked or fixed relative to the stationary bar 122, and that can releasably lock or fix the handle 124. The handle support is releasable also to allow interchanging of handles. The handle support can be a yoke, a bracket, boom, clamp, tube, cantilever, grip, split, bar, stay, or strut. In many cases, the handle support is preferably a releasable and lockable structure. In the example of the handle support 126 shown in FIGS. 1-7, the handle support is formed from two portions separable from each other. The handle support in the configuration shown in FIGS. 1-7 has a lower bar 150 and an upper bar 152, which are substantially identical to each other and mirror images, except for the means for securing the lower and upper bars together. It should be understood that the terms “upper” and “lower” are used only for identification with consideration of the particular layout in FIG. 7, but the particular orientation of one and the other relative to the ground is not relevant in most circumstances.

The lower and upper bars include respective mating body portions 154 to and 156 to be joined together by fasteners 158. The body portions 154 and 156 include mating surfaces 160 and 162 contacting each other when the upper and lower bars are placed together. The body portions may be made from a number of materials, but in the configuration shown in FIG. 7, the bars are cast metal parts.

The lower bar 150 includes a first support surface 164 to help with a first support surface 166 on the upper bar 152 in positioning the handle assembly on the stationary bar 122. Each of the support surfaces 164 and 166 have surface configurations that conform at least in part to the surface configuration of the stationary bar 122. The surface configurations are preferably such that the handle support can move along the stationary bar 122 while also restricting pivoting movement, as desired such as when the support surfaces are locked down. The surface configurations can be round, polygons or a unique cross-sectional profile, for example for keying. The texture of the surfaces may be smooth, striated, knurled or other texture that may be used to enhance the reliability of securing or fixing the handle assembly on the stationary bar 122 while still allowing the handle support to move along the stationary bar and/or to pivot when released. In the examples shown in FIGS. 1-7, the support surfaces 164 and 166 extend transversely of the handle support a distance greater than the width of the body portions 154 and 156, but they can be equal to or less than the width of the body portions. The transverse distance is preferably selected so as to provide the desired reliability for holding the handle support in place until released.

The lower bar also includes a second support surface 168 and the upper bar includes a second support surface 170 for supporting the handle 124. Each of the second support surfaces have surface configurations that conform at least in part to the surface configuration of the handle 124. The surface configurations are preferably such that the handle can move along the surfaces when the handle is released for movement, as desired. As with the surface configurations of the first support surfaces, they can be round, polygons or a unique cross-sectional profile. Additionally, the texture of the surfaces may be smooth, striated, knurled or another texture that may be used to enhance the reliability of securing or fixing the handle in the handle support while still allowing the handle to move when released. The second support surfaces can extend transversely of the handle support a distance greater than the width of the body portions, but they can be equal to or less than the width of the body portions. The transverse distance also is preferably selected so as to provide the desired reliability for holding the handle in place until released.

In the example shown in FIGS. 1-7, the handle support includes a front clamping end 172 and a back clamping end 174. The front clamping end 172 releasably secures the handle support about the stationary bar 122, and the back clamping end releasably secures the handle 124 within the handle support. The front clamping end 172 includes a lower tab 176 opposite an upper tab 178 on the upper bar 152, and when the lower and upper tabs are brought closer together, they squeeze the first support surfaces 164 and 166 together, for example around the stationary bar 122. Typically, a sufficient gap 180 (FIG. 6) is provided between the upper and lower tabs to allow a sufficient clamping force about a properly dimensioned stationary bar 122. Likewise, the back clamping end 174 includes a lower tab 182 and an upper tab 184 opposite the lower tab when the handle support is assembled. Bringing closer together the upper and lower tabs squeezes the second support surfaces together, for example around the handle 124. A sufficient gap 186 (FIG. 6) allows the desired clamping force about the handle when the outside diameter (or other dimension) of the handle is properly dimensioned.

The handle support is releasably fixed on and supported by the stationary bar 122. The handle support includes a releasable securing element 188. The securing element 188 may be a quick release clamp element for clamping the first support surfaces about the stationary bar. The clamp element may be an indexing tightening assembly with a quick-release knob 190.

The handle 124 is releasably secured in and supported by the handle support 126 through a removable fastener assembly. In the example shown in FIG. 7, the fastener assembly is a nut and bolt combination 191, but the fastener assembly can be the same assembly as is used at the front clamping end. Other means for releasably securing the handle in the handle support, or the handle support on the stationary bar, can be used.

In use, the operator may pivotally adjust the handle assembly 52 by releasing the knob 190 so that the handle is approximately horizontal or slightly above horizontal, as well as approximately centered between the sides of the saw. With the handle assembly approximately horizontal or slightly higher, the operator has more leverage to tilt the saw back, thereby lifting the blade, for moving the saw. The handle 124 is positioned in the handle support 126 at its most commonly used position, while still allowing adjustments in lateral position by releasing the knob 190. When the saw is in position for cutting, the handle can be pivoted and moved laterally to the desired position, for example pivoted to about waist height for the operator and moved sideways. If the handle is moved sideways to make easier observation of the blade or cutting operation, the blade can be positioned at a comfortable position for the operator. If the handle is moved sideways to counter the drag force from the blade, the handle is preferably moved so that the plane containing the blade bisects the handle. The operator then guides the saw while standing approximately behind the blade. Other lateral positions may be more desirable, depending on the configuration of the saw and the operator's experience with the saw in cutting along the desired line.

When a handle is moved laterally to a second position, such as where a portion of the handle extends beyond an outer-most boundary of the saw or is behind the saw blade, the operator can more easily see the cutting operation. Additionally, the operator can stand to the side of the saw center, for example with the operator's feet behind the handle or even further outboard of the handle, making it easier for the operator to view the cutting operation. Therefore, when the handle is centered (as determined by the mid-way point between the left and right handle ends) to the side of the saw center, the operator can stand off-center from the saw. When the handle is centered approximately in the plane 140, the operator can guide the saw when standing substantially directly behind the blade, or even outside the blade. Moreover, if the operator is inclined to lean outward to view the cutting operation, it is easier to do so, or even to step further outboard of the saw when the handle is centered in the plane 140. Additionally, where the operator pushes or guides the saw by placing both hands at the ends of the handle, the force applied to the handle by the operator's two hands on the handle applies the force substantially aligned with the blade. Where the handle has a length approximately equal to the saw width, the force applied from the handle then is within approximately 10% of the saw width from the blade position when the blade is positioned at the side of the saw.

In the examples shown in FIGS. 1-7, the handle 124 is movable laterally in the handle support 126 until a handle grip 130 or 132 contacts the handle support, or if there is no grip until the end of the handle is inside the handle support. For additional flexibility in the amount the handle can be moved within the handle support, the grips can be dimensioned to maximize the lateral movement range for the handle. Additionally, for a given grip size the handle can be made longer to allow greater lateral movement of the handle within the handle support.

In other configurations, the handle assembly and the stationary bar could be modified so that the handle support 126 is fixed relative to either the stationary bar 122 or relative to the handle 124. Where the handle support 126 is fixed relative to the stationary bar 122, the handle support allows the handle to move laterally, such as after releasing a releasable clamp.

Additionally, the stationary support bar 122 could be made to pivot relative to the saw frame, thereby allowing the handle to raise and lower. Where the handle support 126 is fixed relative to the handle 124, the handle support could extend into a hollow tube movable or fixed relative to the stationary bar 122. Lateral handle movement could come through movement of the handle relative to the handle support or through lateral movement of the handle support relative to the support bar, such as through a collar on the bar 122. A collar arrangement could be movable on the bar 122, and it could be fixable to discreet positions such as through a pin and pin holes or other releasable securing means. Suitable releasable locking elements can be used to permit repositioning of the handle, as desired. Additionally, lateral handle movement could be made to discreet positions rather than continuously positionable as in the example of FIGS. 1-7. The positions can be discreet such as by using holes and a pin to latch or releasably lock the handle in place according to the pin being placed in a selected hole in the handle. Pivoting movement of the handle can also be accomplished by resolving the pivoting movement into multiple linear movements of the handle to move the handle to the desired position.

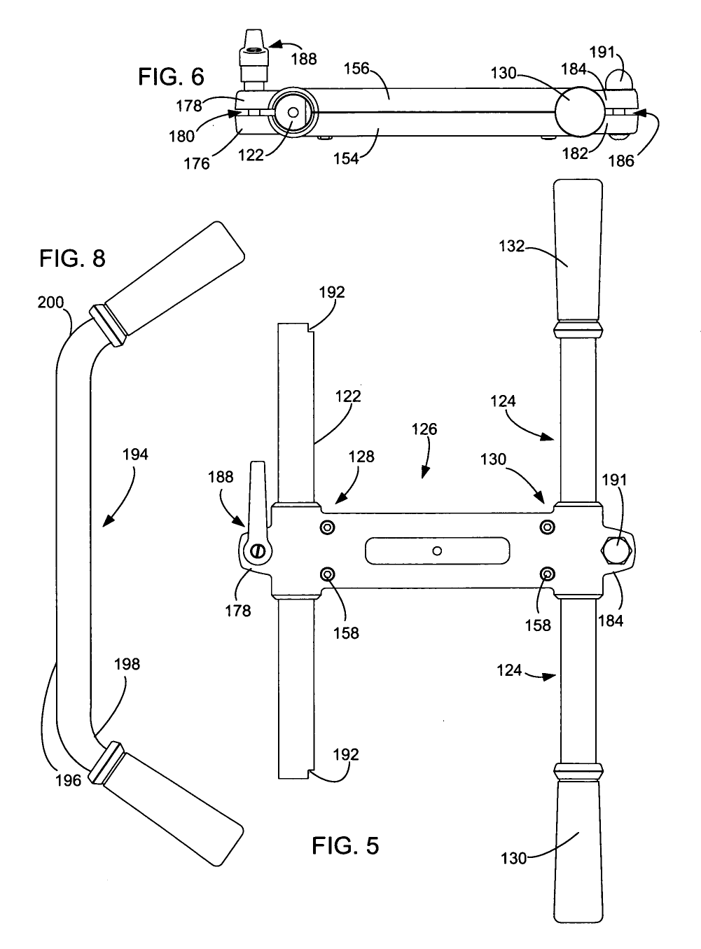

In the examples of the stationary handle 122 shown in FIGS. 5 and 6, the ends of the handle include notches or grooves 192 for engaging complementary surfaces in the side brackets 114 and 118. In an alternative for pivoting movement of the handle assembly 52, or in addition thereto, the stationary bar 122 may include additional surfaces such as flats or angled surfaces allowing the handle to pivot relative to the side brackets 114 and 118. Where the additional surfaces are flats or angled surfaces, such as hexagonal, the bar 122 can be moved pivotally or repositioned through discrete angles defined by the flats or surfaces, thereby pivoting the handle assembly 52 relative to the saw. In the case of a hexagonal outer surface, the angles would be approximately 30 degrees. Pivoting movement of the bar 122 can be in addition to or a substitute for pivoting movement of the handle assembly.

Other examples of handles are shown in FIGS. 8-12. In one alternative, a handle 194 (FIG. 8) includes a bar having a relatively straight portion 196 and left and right curved portions 198 and 200, respectively. The curved portions terminate in straight end portions for receiving respective grips, so that the handle 194 approximates an open or diverging, flat-bottomed U-shape. With the handle 194, the handle can be supported in the same handle support 126 as the handle 124 (FIG. 5), or it can be supported by a frame support laterally fixed relative to the rest of the saw, for example. The handle 194 is pivotable, for example with the handle support 126 about the stationary bar 122, and is movable laterally with the handle support and/or within the handle support. The extent of lateral movement of the handle 194 within the handle support is determined by the length of the straight portion of the handle 196 between the curved portions 198 and 200. The angles defined by the straight portion 196 and the end portions may be selected as desired. The use of the handle is substantially the same as that described with respect to the example of FIGS. 1-7.

Laterally movable handles can be used from a number of positions on the saw. The laterally movable handle 124 can be positioned closer to or farther from the stationary bar 122, or the handle 124 can telescope within or outside the stationary bar 122 or its brackets. A handle can also be positioned at other locations on the saw. For example, a handle 202 can be supported on the lifting cage 204 of the saw. In one example shown in phantom in FIG. 4, the handle 202 is supported by the lifting cage through a transverse bar 206 so that the handle 202 can be positioned above and a short distance behind the saw blade 60. The handle 202 can telescope within the transverse bar 206, or the handle 202 can be otherwise supported by the bar 206 such as through a support tube on the transverse bar 206. In another example shown in phantom in FIG. 4, the handle 208 is supported to be laterally movable at another portion of the saw. Specifically, the handle 208 is supported by a transverse bar 210 of the lifting cage so that the handle 208 can be supported over a portion of the saw blade. The handle 208 can telescope within or outside the transverse bar 210, or the handle 208 can be supported otherwise by the bar 210. In the example depicted in FIG. 4, the handle bar 208 telescopes inside the transverse bar 210, and can be supported by the transverse bar in such a way as to allow the handle 208 to extend on each side of the plane 140 containing the blade.

Each of the handles 202 and 208 can be releasably fixed so the handle can be positioned by the operator as desired. Suitable clamps, locks or other holding mechanisms can be used to keep the handle reliably in place during operation of the saw. Other holding mechanisms may include latches, detents, pins or other holding elements. Holding mechanisms and holding elements can be omitted, for example in favor of allowing the operator to hold the handle in place during operation, but some means of fixing the position of the handle during operation is preferred. Attentively, the saw can be configured so that a handle can be positioned at several locations on the saw wherein for each location on the saw of the handle has a single lateral position. For example, the handle 202 can be supported by the transverse bar 206 at a single lateral position, and when the handle 202 is not in use it can be stowed or removed elsewhere. Likewise with the handle 208. Additionally, a single handle can be positioned at a number of locations on the saw forward or backward of the stationary bar 122, and above or below the level of the stationary bar 122. Similarly, multiple handles can be used at any given time. For example, the operator can use the handle 124 and the stationary bar 122 to manipulate or guide the saw, or the operator can use the handle 124 and the handle 202 or the handle 208. As a further alternative, either of the handles 202 and 208 can be used as a bar equivalent to bar 122 and a handle assembly 52 supported by the handle 202 or by the handle 208. Use of the handles 202 and 208 and the operation of a saw with one or both of these handles is substantially the same as that described with respect to FIGS. 1-7, with the additional capability of moving and/or guiding the saw more from the side of the saw or entirely from the side of the saw. The operator can stand or guide the saw from the side of the blade or from behind and outboard of the blade.

Any of the handles or portions thereof described herein can be used at a number of positions on the saw, and they can take a number of configurations at those positions. Additionally, the handles can be supported in a number of ways to allow them to be movable, either laterally, vertically or pivotally, or both. Furthermore, portions of one handle described can be combined with portions of another handle to get a desired characteristic or feature for use with the saw. The handle configurations are therefore not limited specifically to the examples described herein.

The descriptions herein of the handles, their positions, other configurations and their uses can be repeated for handle positions extending toward the left side of the saw. For example, where the saw blade and blade guard are supported on the left end of the blade shaft, the descriptions herein of the handles being movable to the right also apply to the handles for being movable to the left. The handles may be movable laterally in either direction relative to the rest of the saw, or the handles may be configured to be movable only to one side or the other.

In another example of a handle, a handle 212 includes at least one and preferably a plurality of telescoping portions (FIG. 9). The telescoping portions allow multiple lateral positions for handle areas that may be used for gripping. In the example of the handle 212, the handle includes an at least partially hollow tubular portion 214, shown in the example of FIG. 9 as being a substantially straight tube. A right telescoping portion 216 slides into and out of a right end portion 218 of the tube 214, and is laterally movable relative to the tube 214. The right telescoping portion 216 may be releasably held in place through suitable holding or locking means (not shown). Likewise, the left telescoping portion 220 slides into and out of a left end portion 222 of the tube 214, and preferably is also laterally movable relative to the tube 214. The left telescoping portion 220 also may be releasably held in place through suitable locking or holding means. Right and left grips 224 and 226, respectively, may be placed on corresponding telescoping portions for operator comfort or to indicate an area for gripping the handle.

The handle 212 provides a structure for laterally changing the length of the handle, and it also serves to move a portion of the handle laterally. Additionally, the handle can be moved to place part of the handle, such as a telescoping portion, across the plane of the blade, thereby moving the handle laterally. When the handle 212 in the example of FIG. 9 is used in the handle assembly 52, the handle can be moved laterally in the handle support 126, by moving the handle support along the bar 122, and/or by moving one or both of the telescoping portions 216 or 220 relative to the tube 214. The handle 212 provides additional flexibility in lateral movement of a given handle in the examples of the saw described herein. In this example, the handle portion intermediate the ends remains in place and intact (compare the handle of FIG. 11) when the telescoping portions are moved, and any handle support need not be changed or adjusted in order to move the telescoping portions laterally. With the intermediate portion intact, the handle can be moved easily within a handle support such as the handle support 126, thereby adding flexibility in use. Additionally, one of the telescoping portions and corresponding grips can be omitted, and the remainder of the assembly can be used as a handle in a way such as that described with respect to the handles 202 and 208 shown in phantom in FIG. 4. Use of the handle and operation of the saw with a handle such as handle 212 in FIG. 9 can be substantially similar to that described with respect to FIGS. 1-7.

Another example of a handle 228 (FIG. 10) uses a pivoting movement to move at least a portion of the handle laterally. The example of the pivoting movement in FIG. 10 allows the handle position effectively to be changed without changing a middle portion of the handle. In this example, the handle length is effectively increased. The handle 228 includes at least a first extension portion 230 at an end of portion 232 of the handle 228. The end portion 232 is outboard of an intermediate portion 234 of the handle, which intermediate portion can be used to support the handle through another structure on the saw, such as the support element 126. The first extension portion 230 is supported at an end of the handle by hinges 236 on each side of the extension portion. The hinges in this example allow the extension portion to pivot relative to the handle through an angle of about 180 degrees so that a portion of the handle is moved laterally, and the length of the handle is extended by approximately the length of the extension portion 230. In this example, the extension portion pivots about an axis that is substantially horizontal, and one that is spaced substantially from the center of the saw.

The extension portion 230 can be in the form of a half pipe cut from the handle 228, leaving the rest of the half pipe exposed when the extension portion is extended. The length of and the arcuate extent of the extension portion 230 (in cross section) can be selected as desired, and a cross-section of the extension portion can be a half circle or otherwise. Various surfaces and reinforcement portions can be included to provide the desired strength in the handle. Additionally, the handle can take forms other than a hollow pipe. If the handle were not hollow, for example, movement of an extension portion would expose a smaller dimensioned area that could still be grasped by an operator. For example, an underlying bar could have a smaller cross sectional area, with the extension portion overlying the bar when the extension portion is unextended.

The handle can also include a second extension portion 238 supported on suitable hinges 240 for pivoting movement relative to the intermediate portion 234 of the handle. As with the first extension portion 230, the second extension portion 238 can pivot so that a portion of the handle is moved laterally, effectively increasing the length of the handle and moving a portion of the handle laterally relative to the saw. Depending on the dimensions of the extension portions relative to the intermediate portion 234, intermediate portion can be used to support the handle and permit lateral movement of the handle relative to the support. For example, where the extension portions form two thirds of the overall length of the handle, the middle third can be used to support the handle on the frame. Alternatively, the extension portions could be pivotally attached to the outside of a bar, all or a substantial length of which bar could be used to move the handle laterally in a handle support such as the handle support 126. In this configuration, the lengths of each of the extension portions could be about half the overall length of the handle when the extension portions are not extended. In another alternative, the extension portions could be longer than half the handle length, in which case one extension portion would overlap another extension portion when they are not extended.

Another pivoting handle arrangement can be used to move a handle portion laterally relative to the rest of the saw. In the example shown in FIG. 11, a movable handle 242 can take the place of the stationary bar 122, and the handle 242 can be used both between the sides of the saw and outside one or both sides of the saw, depending on the handle configuration. The handle 242 can be used with or without the handle assembly 52. The handle 242, or a portion thereof, can pivot relative to the frame, so that the handle can extend at least partly laterally beyond the side of the console or other frame element supporting the handle.

In the example of the movable handle 242 shown in FIG. 11, the handle includes a right end portion 244 supported by a right bracket 246 on a portion of the frame. The right bracket 246 is substantially similar to the right bracket 118 described with respect to FIGS. 1-4, except that in the configuration shown in FIG. 11, the right bracket 246 can pivot clockwise (or counterclockwise or both, if desired) about an axis substantially normal to the surface of the frame or console to which the bracket is mounted, as represented by the clockwise-directed arrow 248. A releasable latch, clip or other engagement can be incorporated into the left bracket 250 to releasably hold the left portion 252 of the handle 242. By releasing the latch, the left portion 252 can pivot in the direction of the arrow 254, so the handle 242 can be moved laterally, such as from a point inside the sides of the frame portion supporting the handle to a point outside. For example, the handle can pivot so that the handle is outside the right bracket 246, and even extends far enough to pass through a plane containing the saw blade. The extent to which the handle can be positioned laterally of the right bracket 246 will depend on the length of that portion of the handle that pivots.

Likewise, the left bracket 250 can pivot counter clockwise (or clockwise or both, if desired) about an axis substantially normal to the surface of the frame or console to which that bracket is mounted, as represented by the counter clockwise-directed arrow 256. A releasable latch or other engagement can be incorporated into the right bracket 246 to releasably hold the right handle portion 244. By releasing the latch, the right portion 244 can pivot in the direction of the arrow 260, so the handle 242 can be moved laterally, such as from a point inside the envelope defined by the frame portion to a point outside. The configuration of the movable handle on the left side can be a substantial mirror image of the configuration of that on the right side.

In an alternative structure for the handle 242 shown in FIG. 11, the handle can be separated into two portions, such as at the separation represented by the dashed lines 262. In this alternative configuration, the left side of the handle can pivot counter clockwise while the right side can remain stationary. Additionally, the right side of the handle can pivot clockwise while the left side remains stationary. Other configurations for a pivoting handle can also be used.

Use of the handle and operation of the saw with a handle such as handles 228 and/or 242 in FIGS. 10 and 11 can be substantially similar to that described with respect to FIGS. 1-7, except that portions of the handles are movable pivotally to change a lateral position of the handle. For example, the operator can move a portion of the handle pivotally about an axis substantially different from an axis transverse to the saw so that the handle or handle portion is in a second lateral position different from the first (for example about an axis substantially different from the axis of the fixed bar 122 in FIG. 1). In the examples of the handles 228 and 242, portions of the handles can pivot about axes that are substantially parallel to the saw cutting direction and they can be moved so as to extend outboard of the sides of the saw.

In another configuration of the stationary bar 122, a non-circular bar 264 is shown in FIG. 12. This bar can be fixed relative to the frame by supporting brackets (similar to the brackets 114 and 118 in FIGS. 14), or the bar can pivot relative to the frame. Pivoting the bar 264 allows raising and lowering a handle assembly 266, substantially the same as the handle assembly 52, except for the configuration of the support surfaces 268 and 270 about the bar 264. The handle assembly 266 will not be described further, and the structure and function of the handle assembly is substantially the same as that described above with respect to the handle assembly 52 except that the handle assembly can pivot in increments corresponding to the faces of the non-circular bar 264.

In the configuration shown in FIG. 12, the bar 264 has a substantially hexagonal outer configuration. It can have other polygon configurations or sides having unequal lengths. The handle assembly 266 is supported on the hexagonal bar by a substantially conforming set of surfaces 268 and 270 combining to form a hexagonal opening 272. The releasable clamp 188 secures the handle assembly relative to the hexagonal bar 264 at the desired lateral position along the bar and at the desired angle from the horizontal. Other configurations of the bar and handle assembly can be used to securely hold the handle assembly in place while allowing repositioning of the handle assembly by loosening the clamp 188. Use of the handle and operation of the saw with a handle such as handle 266 in FIG. 12 can be substantially similar to that described with respect to FIGS. 1-7.

Having thus described several exemplary implementations, it will be apparent that various alterations and modifications can be made without departing from the concepts discussed herein. Such alterations and modifications, though not expressly described above, are nonetheless intended and implied to be within the spirit and scope of the inventions. Accordingly, the foregoing description is intended to be illustrative only.

What is claimed is:

1. A saw comprising:
a frame;
wheels supporting the frame;
a blade support supported relative to the frame;
a handle support element supported by the frame;
a link supported on the handle support element in such a way that the link is movable on the handle support element; and
a handle supported by the link wherein the handle is movable relative to the link.

2. The saw of claim 1 wherein the handle support element is laterally fixed relative to the frame.

3. The saw of claim 2 wherein the handle support is pivotable relative to the frame.

4. The saw of claim 2 wherein the handle support element has a circular cross-section.

5. The saw of claim 1 further including a releasable clamping element for releasably clamping the link on the handle support element.

6. The saw of claim 5 wherein the releasable clamping element includes a knob.

7. The saw of claim 5 wherein the releasable clamping element is releasable to allow the link to move laterally on the handle support.

8. The saw of claim 5 wherein the releasable clamping element as releasable to allow the link to move pivotally on the handle support.

9. The saw of claim 1 wherein the link is a split yoke.

10. The saw of claim 1 wherein the handle includes a straight bar portion.

11. The saw of claim 1 wherein the handle is movable laterally relative to the saw.

12. The saw of claim 1 further including at least one grip on the handle.

13. The saw of claim 1 wherein the saw includes an approximate center line and further including a saw blade supported on the saw spaced from the center line and wherein the handle is movable laterally so that a portion of the handle intersects a plane containing the saw blade.

14. The saw of claim 13 wherein a portion of the handle extends on a side of the plane opposite the saw.

15. A movable saw comprising:
a frame having first and second sides and being supported on a surface so as to be movable;
a blade support configured to support a blade such that the blade is at a first side of the frame;
a handle having a handle surface sufficiently large to allow handling by a saw operator, and wherein the handle is supported by the frame in such a way that at least part of the handle is movable sideways relative to the saw.

16. The saw of 15 wherein the handle has a first end portion extending toward a first side of the frame and wherein the handle end portion includes a portion that is movable into a plane that includes the blade when the blade is supported by the blade support.

17. The saw of 15 wherein the saw has a first width extending between the first and second sides and wherein the handle has a length approximately the same as the width.

18. The saw of claim 15 wherein the handle has a length that is approximately 90 percent of the saw width.

19. The saw of 15 further including a handle support extending between the frame and the handle, and wherein the handle support is configured to allow the handle to move sideways relative to the handle support.

20. The saw of claim 19 wherein the handle support is movable sideways.

21. The saw of claim 19 wherein the handle support is movable other than sideways.

22. The saw of claim 19 wherein the handle support is movable sideways and in other directions than sideways.

23. The saw of claim 19 wherein the handle support includes a clamp for releasably fixing the handle support relative to the frame.

24. The saw of claim 19 wherein the handle support is movable to a position other than at a center of the saw.

25. The saw of claim 15 further including at least one handle grip on an end of the handle and wherein the handle and the grip have respective lengths whereby the grip can be moved to a position in a plane that includes the blade when the blade is supported by the blade support.

26. The saw of claim 15 wherein the handle is movable sideways on the saw so that the handle surface is within a distance to a plane that includes the blade wherein the distance is about 10% of the width of the saw.

27. The saw of claim 15 wherein the handle is a straight handle.

28. The saw of claim 15 wherein the handle is a curved handle.

29. The saw of claim 15 wherein the handle has a length that is changable.

30. The saw of claim 15 wherein the handle includes a telescoping portion.

31. The saw of claim 15 wherein the handle includes a folding portion.

32. The saw of claim 15 wherein the handle is slidable.

33. The saw of claim 15 wherein the handle is movable in increments.

34. The saw of claim 15 further including a frame bar and a handle support movable sideways on the frame bar and wherein the handle support supports the handle relative to the frame.

35. The saw of claim 34 wherein the frame bar is pivotable relative to the frame.

36. The saw of claim 34 wherein the frame bar is movable relative to the frame.

37. The saw of claim 34 wherein the frame bar is fixed relative to the frame.

38. The saw of claim 37 wherein the frame bar has an outside surface that has a polygonal cross section.

39. The saw of claim 38 wherein the polygonal cross section is a hexagonal shape.

40. The saw of claim 15 further including a handle support extending between the frame and the handle and wherein the handle support is movable relative to the frame.

41. The saw of claim 40 wherein the handle support is a yoke.

42. The saw of claim 41 wherein the yoke includes two pieces separable from each other.

43. The saw of claim 41 wherein the yoke includes a first end, wherein the first end and the handle are movable relative to each other and further including a second end movably supported relative to the frame.

44. The saw of claim 43 wherein the second end is movably supported for lateral movement and for pivoting movement.

45. The saw of claim 44 wherein the second end includes a non-circular surface for limiting an angular position of the yoke.

46. The saw of claim 45 wherein the non-circular surface is a hexagonal shaped surface.

47. The saw of claim 41 further including a releasable element for releasably locking the yoke relative to the frame.

48. The saw of claim 41 wherein the yoke is separable into two pieces along a horizontal plane.

49. The saw of claim 41 wherein the yoke includes a body portion having a width and wherein the yoke includes a frame end supported by a portion of the frame wherein the frame end is narrower than the body portion width.

50. The saw of claim 41 wherein the yoke includes a first end portion and a second end portion and wherein both the first end and the second end portions are releasably securable.

51. The saw of claim 40 wherein the handle support is positioned at approximately a waist height of an operator.

52. The saw of claim 51 wherein the handle support is movable laterally and pivotally.

53. The saw of claim 51 further including an upper portion on the handle support and further including a releasable securing device on an upper portion of the handle support.

54. The saw of claim 15 wherein the handle includes at least one grip having a length and wherein the handle has a length such that the handle when moved laterally such that the grip contacts the handle support places a force applied to the handle by two hands on the handle within approximately 10% of the saw width from the blade position when the blade is positioned on the blade support.

55. The saw of claim 15 wherein the handle includes a telescoping element.

56. The saw of claim 15 wherein the handle includes a folding element.

57. The saw of claim 15 wherein the handle includes a sliding element.

58. The saw of claim 57 wherein the sliding element is a tube slidable relative to the handle support.

59. The saw of claim 57 wherein the sliding element is a first tube slidable within a second tube.

60. The saw of claim 15 wherein the handle support is laterally slidable relative to the frame.

61. The saw of claim 15 wherein the handle is movable relative to the handle support to a defined set of discrete positions relative to the handle support.

62. The saw of claim 15 wherein the handle is movable to change a vertical position of the handle.

63. The saw of claim 15 wherein the saw has a first width extending between the first and second sides and wherein the handle has a length greater than the first width.

64. A concrete saw comprising a saw frame for supporting a saw blade to one side of the frame and a handle supported by the frame wherein handle is supported on the frame in such a way as to allow at least partially lateral movement of the handle relative to the frame.

65. The saw of claim 64 wherein the handle is supported on the frame by a yoke wherein the yoke is movable relative to the frame.

66. The saw of claim 65 wherein the yoke is supported on the frame by a bar.

67. The saw of claim 65 wherein the yoke is movable substantially horizontally.

68. The saw of claim 65 wherein the yoke is movable pivotally.

69. The saw of claim 65 wherein the yoke has a yoke surface where the yoke is supported on the frame and the yoke surface includes an angled surface.

70. The saw of claim 69 wherein the yoke surface has an internal polygon surface.

71. The saw of claim 70 wherein the yoke internal surface is hexagonal.

72. The saw a claim 65 wherein the yoke is a split yoke.

73. The saw of claim 72 wherein the yoke is split longitudinally.

74. The saw of claim 65 wherein the yoke has a body having a width and wherein an end of the yoke is narrower than the width of the yoke body.

75. The saw of claim 65 wherein the yoke is releasably adjustable.

76. The saw of claim 75 wherein the yoke is releasably adjustable at a portion of the yoke where the yoke is supported on the frame.

77. The saw of claim 75 wherein the yoke is releasably adjustable at a portion where the handle is supported by the yoke.
